(19) United States
(12) Patent Application Publication
(10) Pub. No.: US 2021/0373564 A1
(43) Pub. Date: Dec. 2, 2021

(54) SELF-PROPELLED SURFACE TREATMENT UNIT WITH AN ENVIRONMENTAL MAP

(71) Applicant: Vorwerk & Co. Interholding GmbH, Wuppertal (DE)

(72) Inventors: Ralf EICKENBERG, Solingen (DE); Andres SAUERWALD, Bottrop (DE)

(73) Assignee: Vorwerk & Co. Interholding GmbH, Wuppertal (DE)

(21) Appl. No.: 17/335,138

(22) Filed: Jun. 1, 2021

(30) Foreign Application Priority Data
Jun. 2, 2020 (DE) 10 2020 114 660.4

(51) Int. Cl. G05D 1/02; A47L 9/28; A47L 9/00

(52) U.S. Cl. CPC G05D 1/0217; G05D 1/0214; G05D 1/0274; A47L 9/2852; A47L 2201/06; A47L 9/2826; G05D 2201/0215; A47L 2201/04; A47L 9/009

(57) ABSTRACT

A self-propelled surface treatment unit has a drive device for the autonomous travel of the surface treatment unit within an environment, an energy storage device, a data storage device having an environmental map of the environment, and a navigation device for the navigation and self-location of the surface treatment unit within the environment on the basis of the environmental map having environmental zones. In order to improve the efficiency and service life of the energy storage device, the environmental map has energy data for at least two environmental zones, which indicates the amount of energy that the surface treatment unit will require to treat the surface in each one of the environmental zones.

### CROSS REFERENCE TO RELATED APPLICATIONS

Applicant claims priority under 35 U.S.C. § 119 of German Application No. 10 2020 114 660.4 filed on Jun. 2, 2020, the disclosure of which is incorporated by reference.

### BACKGROUND OF THE INVENTION

### 1. Field of the Invention

The invention relates to a self-propelled surface treatment unit with a drive device for the autonomous travel of the surface treatment unit within an environment, an energy storage device, a data storage device having an environmental map of the environment, and a navigation device for the navigation and self-location of the surface treatment unit within the environment, on the basis of the environmental map, wherein the environmental map has environmental zones.

The invention furthermore relates to a method for the operation of such a surface treatment unit.

### 2. Description of the Related Art

Surface treatment units of the aforementioned type are reasonably familiar from the prior art. These can, for example, be floor or ground surface treatment robots, such as cleaning robots, mowing robots, polishing robots, grinding robots, surface polishing robots, or similar. A floor or ground surface treatment unit usually comprises at least one surface treatment element that is used for the surface treatment activity of the surface treatment unit, for example, a cleaning element such as a brush, or a wiping element, a polishing element, a grinding element, a mowing tool, or similar. It is of known art to provide such surface treatment units with a navigation device, which is designed to navigate and locate the surface treatment unit within an environment. To this end, the surface treatment unit accesses an environmental map, which is, for example, generated by the surface treatment unit itself. For this purpose, the surface treatment unit can use a so-called SLAM method (simultaneous localisation and mapping). During a surface treatment activity, the surface treatment unit can determine its own position within the environmental map and can follow a movement path. Here it is also of known art to note in the environmental map which environmental zones are visited in the course of a treatment route.

Furthermore, it is of known art that the control and evaluation device of the surface treatment unit controls the surface treatment activity, or activities, on the basis of a surface treatment programme that is planned in advance, wherein the surface treatment programme provides, for example, a number of surface treatment activities in a plurality of environmental zones, which the surface treatment unit then works through one after another. In order to provide energy for the loads on the surface treatment unit, for example motors of a drive device, and/or of a surface treatment element, the surface treatment unit usually has an energy storage device, in particular an accumulator, which can be recharged by means of a charging device. For this purpose, the surface treatment unit can, for example, autonomously couple onto the charging device, for example onto a charging device that is integrated into a service station for the surface treatment unit. Alternatively, a user can manually connect the surface treatment unit, and/or its energy storage device, to the charging device.

In order to perform a number of surface treatment activities as efficiently as possible within the environment, a variety of navigation strategies for the surface treatment unit are of known art. One strategy is to control the surface treatment unit such that an amount of energy available in the energy storage device is used to treat as large a surface area of the environment as possible, ideally 100 percent of all the environmental zones to be treated. Alternatively, provision can be made to achieve a treatment of the environment within the shortest possible period of time.

A disadvantage of the treatment strategies of known prior art is that the energy extraction from the energy storage device for treatment activities is not matched to the electrochemical properties of an accumulator, that is to say, the service life of the energy storage device may be unintentionally shortened, and/or an existing maximum capacity may not be optimally utilised.

### SUMMARY OF THE INVENTION

Based on the aforementioned prior art, it is the object of the invention to create a self-propelled surface treatment unit, together with a method for its operation, which takes into account the electrochemical properties of accumulators, in particular lithium-ion accumulators, wherein, in particular, the service life of the energy storage device, and/or the maximum possible energy storage capacity of the energy storage device, is improved.

For the achievement of the aforementioned object, it is proposed that the environmental map of the surface treatment unit has energy data for at least two environmental zones, which indicates the amount of energy that the surface treatment unit will require for the surface treatment of the respective environmental zone.

In accordance with the invention, information is now stored in the environmental map, in particular a persistent environmental map of the surface treatment unit, which information indicates the amount of energy required to perform the surface treatment of the associated environmental zone by means of the surface treatment unit. The energy data can either be stored in the environmental map itself, namely in conjunction with the associated environmental zone, or linked to the environmental map, so that the storage of the energy data takes place in a file that is different from the environmental map. The amount of energy for the surface treatment of the respective environmental zone is related to a defined surface treatment activity of a specific surface treatment unit, wherein the defined surface treatment activity can be, for example, a standard surface treatment activity that the surface treatment unit automatically performs by default in the absence of an activity particularly selected by a user. Such a standard surface treatment activity can be, with respect to a surface treatment unit designed as a vacuum cleaner, for example, a suction cleaning activity with a preset, specific power level, i.e., suction level, and, if applicable, a rotational speed of a cleaning element. Furthermore, provision can also be made for a plurality of energy data to be stored for each environmental zone, which refer to different surface treatment activities, for example surface treatment activities with different surface treatment intensities, or surface treatment activities that are performed with the aid of different cleaning elements of the same surface treatment unit. Such energy data can be stored with respect to the activity, for example in a table, which is linked to the environmental map, and/or to the respective environmental zone. On the basis of the environmental map provided with energy data, a control and evaluation device of the surface treatment unit can now, for example, schedule such an environmental zone as a location for treatment, which zone is particularly advantageous with respect to the current state parameters of the energy storage device. Particularly preferably, such an environmental zone can be treated within the context of a subsequent surface treatment activity, which requires a relatively large amount of energy for the optimal performance of the defined surface treatment activity. By the extraction of a relatively large amount of energy, an energy storage device that is in a cold state can advantageously be heated. This is based on the premise that at the start of a work schedule the load on the energy storage device should be as high as possible, so that the energy storage device thereby heats up as quickly as possible, and the specific internal resistance of the energy storage device decreases. By the selection of a particularly energy-intensive environmental zone, the energy storage device can thus be moved particularly quickly from a cold state into a heated state, so that an efficient energy output can be achieved. Needless to say, here it should also be ensured that the energy storage device is never heated above a specific maximum temperature, which would otherwise negatively affect the service life and quality of the energy storage device.

In particular, provision can be made for the amount of energy to be determined as a function of a surface type present in the environmental zone, and/or for the amount of energy to be determined as a function of an empirically determined amount of energy for the treatment of the environmental zone. In accordance with a first embodiment, a characteristic amount of energy can be calculated that is usually required for a standard surface treatment defined in this manner for the surface treatment of a specific surface type. The surface type can be classified into one of a plurality of categories, for example into hard surfaces and carpeted surfaces, wherein further sub-classifications are possible. Sub-classes of hard surfaces include, for example, tiled surfaces, wooden surfaces, PVC surfaces, and others. Carpeted surfaces or carpets can be subdivided into long-pile carpets or carpeted surfaces, short-pile carpets or carpeted surfaces, and others. The amount of energy, dependent on the surface type, relates in each case to a specific environmental zone, in particular its surface area, and to a defined surface treatment activity, for the performance of which the relevant amount of energy is required. Here the surface treatment activity can be defined by a specific intensity of the surface treatment, by a specific surface treatment parameter of the surface treatment unit set for the surface treatment activity, in particular specific power levels of surface treatment elements, and/or drive devices, or other parameters of the surface treatment unit. Furthermore, the amount of energy can additionally or alternatively be determined empirically. The empirically determined amount of energy is preferably determined on the basis of a surface treatment history of the surface treatment unit. In particular, a plurality of amounts of energy determined from the surface treatment history of the surface treatment unit can be averaged so as to define a characteristic average value of the amount of energy required for a defined surface treatment activity.

Furthermore, it is proposed that the environmental map has surface type data for a surface type represented in the environmental zone, wherein the surface type is selected in particular from a hard surface, a short-pile carpeted surface, or a long-pile carpeted surface. Surface type data is thus stored In the environmental map, or alternatively, in a link with the environmental map, which data identifies environmental zones for whose surface treatment a specific amount of energy is required. Surface types that are particularly energy-intensive include, for example, carpeted surfaces, as opposed to hard surfaces. Furthermore, a surface treatment of a long-pile carpeted surface requires a greater amount of energy than a surface treatment of a short-pile carpeted surface. If a ground surface treatment unit takes the form, for example, of a mowing robot, the surface type can differ according to the height of the grass to be mowed, and/or according to its composition from various types of grass, which require different amounts of energy for the mowing. Similarly, surface type data can also be defined, which is relevant, for example, for a polishing unit or a surface polishing unit, wherein the surface types can be characterised by the mechanical resistance generated by the surface. The surface type data stored in the environmental map enables a control and evaluation device of the surface treatment unit to determine quickly in each case a required amount of energy for one of the environmental zones.

Furthermore, for the environmental zone in question, it is proposed that the environmental map indicates a characteristic amount of energy per unit surface area required for the surface treatment. In accordance with this design, a characteristic amount of energy per unit surface area can already be calculated for each of the environmental zones; this is preferably calculated at the same time as a function of defined surface treatment parameters, for example for a standard surface treatment so defined. In this case, it is no longer necessary for a control and evaluation device to first calculate a required amount of energy ad hoc from surface type data before starting a next surface treatment activity. Instead, the amount of energy required for a defined surface treatment by the surface treatment unit can be determined directly on the basis of the characteristic amount of energy per unit surface area, and a known surface area of the environmental zone to be treated. Here the defined surface treatment follows predefined parameters, which correspond, for example, to a specific speed of movement of the surface treatment unit during the surface treatment activity, a specific surface treatment intensity and, if necessary, further parameters. On the basis of the environmental map and the stored characteristic amounts of energy per unit surface area, it is possible to recognize directly which environmental zones are relatively energy-intensive, and which environmental zones, in contrast, require a smaller amount of energy per unit surface area for the surface treatment.

Furthermore, it is proposed that the surface treatment unit has a control and evaluation device, which is equipped to access the environmental map, to compare the stored amounts of energy with one another and, depending on the stored amounts of energy, to determine a sequence with which the environmental zones are treated in succession. The control and evaluation device thus determines a treatment sequence for a plurality of environmental zones. The treatment sequence includes a number of surface treatment activities that are to be performed in a plurality of environmental zones of the environment. Here the temporal sequence of the surface treatment activities is determined according to predefined rules, which are dependent on the amounts of energy stored in the environmental map, which are required for the treatment of the respective environmental zones. The rule for determining the sequence takes into account the amounts of energy with respect to their magnitude, so that energy-intensive environmental zones are treated at a different point in time within the treatment sequence than low-energy environmental zones.

In this context, it is, in particular, proposed that the control and evaluation device is equipped to determine the sequence such that a first environmental zone, whose surface treatment requires a larger first amount of energy, is treated before a second environmental zone, whose surface treatment requires a smaller second amount of energy, compared to the first amount of energy. This planning rule for the sequence of surface treatments in a plurality of environmental zones takes into account that the energy storage device of the surface treatment unit should be loaded as high as possible at the beginning of a sequence of surface treatment activities, so as to heat up the energy storage device as quickly as possible and bring it up to its operating temperature. The internal resistance of the energy storage device is reduced by the initial power peak of the energy extraction; this leads to protection of the energy storage device and an increase of its service life. The environmental zones with a relatively small amount of energy required are treated as late as possible within the defined sequence, while the environmental zones for which a relatively large amount of energy is required to treat the surface are treated first. The environmental zones are thus treated in a descending order with respect to the amount of energy they require. After the first surface treatment activity, or activities, the energy storage device is then already preheated, and the other environmental zones can be efficiently cleaned in the course of the execution of the defined surface treatment sequence. The surface treatment of the low-energy environmental zones at the end of the defined sequence also has the effect that the energy storage device is then already cooled down again somewhat—with respect to the energy maximum of the defined sequence—and the cooling phase of the energy storage device begins in good time before, for example, the next recharging of the energy storage device. This also protects the energy storage device. Furthermore, as a result of this measure, the energy storage device becomes quickly available once again for the next work assignment.

It is advantageously proposed that the control and evaluation device is equipped to apportion a total amount of energy stored in the energy storage device between a plurality of environmental zones, so that energy-intensive environmental zones are treated first and, in contrast, less energy-intensive environmental zones are then treated in descending order with respect to the amount of energy required, until the total amount of energy stored is fully apportioned. When determining the sequence, the control and evaluation device can already take into account the total amount of energy available, so that, if necessary, surface treatment parameters and/or unit parameters of the surface treatment unit can be adjusted for some or a plurality of environmental zones, and the total amount of energy is preferably sufficient so as to be able to treat fully all environmental zones in a planned sequence. This variant is particularly recommended in cases where a plurality of alternative amounts of energy are defined for an environmental zone, which relate to various (alternative) surface treatment parameters. From this selection of surface treatment parameters the control and evaluation device could select those that are suitable to enable the complete performance of the sequence of treatment activities, and that manage with the total amount of energy stored in the energy storage device.

Furthermore, provision can be made for the surface treatment unit to have an obstacle sensor for the detection of environmental features, and/or a map generation device for the generation of the environmental map on the basis of environmental features, and/or a surface type sensor, which is equipped to determine a surface type present in an environmental zone. In this case, the surface treatment unit has one or a plurality of its own detection devices that detect parameters that are suitable for the generation of the environmental map, as well as for the storage of additional information in the environmental map, or the linkage of additional information to the environmental map. The surface treatment unit can, for example, have an obstacle sensor, which, on the one hand, detects the existence of obstacles in the environment, and, on the other hand, preferably also detects their absolute position in the environment, or their position relative to the location of the surface treatment unit. On this basis, a map generation device of the surface treatment unit can itself then generate an environmental map. It is no longer necessary to operate external obstacle sensors in the environment, or for the environmental map to be generated by an external device. The obstacle sensor can, for example, take the form of a distance-measuring device of the surface treatment unit, which measures distances to obstacles that are present in the environment. Such a distance measuring device preferably measures on the basis of optical measuring methods. In particular, a laser measurement can be undertaken, which measures distances to obstacles around the surface treatment unit. A laser triangulation measuring device is particularly preferably suitable for this purpose. Furthermore, as proposed, the surface treatment unit canal so have a surface type sensor, which detects and recognises the surface type of the environmental zones of the environment. The surface type sensor can, for example, detect whether a surface type of an environmental zone takes the form of a hard surface or a carpeted surface. Particularly preferably, the surface type sensor can further distinguish the surface types according to sub-groups of hard surfaces and carpeted surfaces, for example, a short-pile or long-pile carpeted surface, a tiled surface, a wooden surface, and similar. The surface type can be determined using image processing techniques, wherein the surface type sensor is, for example, a camera that captures images of the floor surface of the environment to be treated. The camera images can then be compared with reference surface types stored in a memory, wherein the surface type of an environmental zone is recognised when a current surface matches a reference type. In addition, a surface type can also be determined by reflectance measurements, wherein it is taken into account that carpets and carpeted surfaces have a lower reflectance than hard surfaces. Furthermore, a surface type can also be detected tactilely, for example by determining a property of a sensor sinking into the material of the surface.

In addition to the above-described surface treatment unit, the invention also proposes a method for the operation of such a surface treatment unit, wherein data is stored for at least two environmental zones of the environmental map, which data indicates the amount of energy the surface treatment unit will require for the surface treatment of the respective environmental zone. The features and advantages described above with respect to the surface treatment unit also ensue accordingly for the method in accordance with the invention. To avoid repetition, reference is also made to the aforementioned statements with respect to the method.

In particular, provision can be made in the performance of the method that a control and evaluation device of the surface treatment unit accesses the environmental map, compares the stored amounts of energy with each other and, depending on the stored amounts of energy, determines a sequence with which the environmental zones are treated in succession. In particular, the sequence can be determined such that a first environmental zone, whose surface treatment requires a larger first amount of energy, is treated before a second environmental zone, whose surface treatment requires a second amount of energy that is smaller, compared to the first amount of energy. In overall terms, energy-intensive zones within the defined sequence are thus preferably treated first, so as to load the energy storage device, preferably an accumulator, as intensively as possible at the beginning of the sequence of treatment activities, so as to preheat the energy storage device, and thus bring it up to its operating temperature. In particular, this prolongs the service life of the energy storage device and ensures an efficient energy supply to the loads on the surface treatment unit. In contrast to strategies known in the prior art for the performance of a plurality of surface treatment activities, the surface treatment unit does not first travel to the nearest environmental zone in the environment with respect to its own position, and perform a surface treatment activity there, but instead travels within the environment to an environmental zone that requires a relatively high, or the highest, amount of energy for the surface treatment. Such an environmental zone can be an environmental zone that is distant from, and not adjacent to, the current location of the surface treatment unit, so that the surface treatment unit has to travel through other environmental zones that are currently not to be treated, so as to reach the environmental zone that is to be treated first.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a surface treatment unit in accordance with the invention,

FIG. 2 shows an environmental map of an environment with a plurality of environmental zones,

FIG. 3 shows a table with parameters of the environmental zones, together with a sequence for the environmental zones along a route of travel,

FIG. 4 shows the environmental map with a route of travel for the surface treatment unit.

### DETAILED DESCRIPTION OF PREFERRED EMBODIMENTS

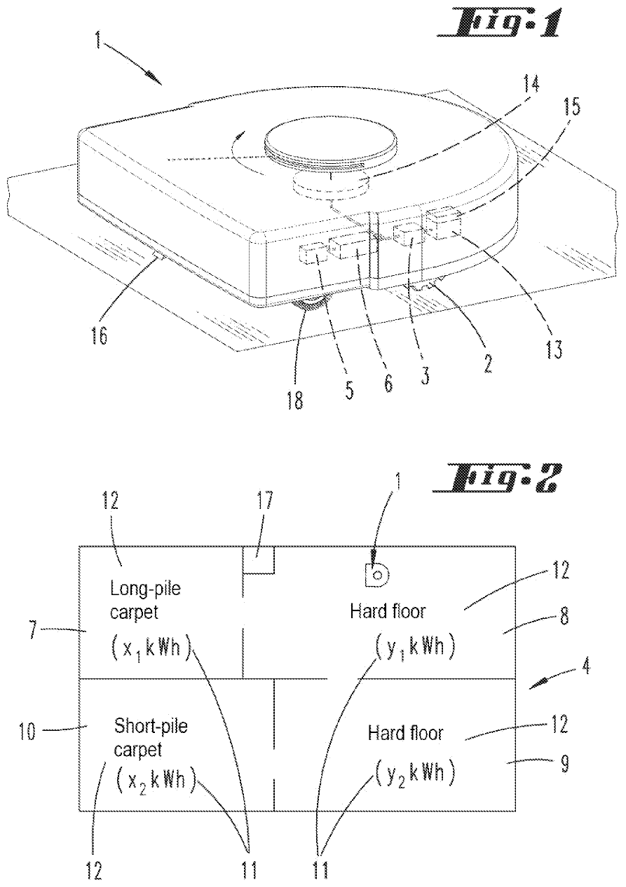

FIG. 1 first shows an exemplary self-propelled surface treatment unit 1, which can, for example, be designed as a cleaning robot. The surface treatment unit 1 has a drive device 2 in the form of wheels, driven by means of an electric motor (not illustrated). The electric motor, together with other electrical loads on the surface treatment unit 1, are supplied with energy by an energy storage device 3. The energy storage device 3 preferably takes the form of a rechargeable accumulator. The surface treatment unit 1 also has an obstacle sensor 14, which is equipped to measure distances to objects that are present in the vicinity of the surface treatment unit 1. Here, the obstacle sensor 14 is, for example, an optical distance measuring device in the form of a laser triangulation measuring device. The obstacle sensor 14 emits a rotating laser beam, which hits objects and is reflected from them. On the basis of the reflected radiation, a distance of the surface treatment unit 1 to the objects can be inferred. The detection signals of the obstacle sensor 14 are used to generate an environmental map 4 (an example of which is illustrated in FIG. 2), which can include a ground plan of the environment, as well as the position of objects within a plurality of environmental zones 7, 8, 9, 10 in the environment. The environmental map 4 is stored in a data storage device 5 of the surface treatment unit 1, and is used by a navigation device 6 to plan a route of travel 19 of the surface treatment unit 1 (see FIG. 4) through one or a plurality of environmental zones 7, 8, 9, 10 of the environment. The route of travel 19 is determined so as to be able to perform a plurality of surface treatment activities by means of the surface treatment unit 1 within the environment, in particular with a sequence determined in terms of time and location, which allows efficient surface treatment of a plurality of environmental zones 7, 8, 9, 10 of the environment. Here the energy storage device 3 of the surface treatment unit 1 is preferably a rechargeable accumulator, which can be recharged at a base station 17, which provides a charging device. The energy accumulator 3 is preferably a lithium-ion accumulator.

In order to perform one or a plurality of surface treatment activities, the surface treatment unit 1 comprises one or a plurality of surface treatment elements 18. Here, the surface treatment unit 1 has, for example, a cleaning roller, rotating around an essentially horizontal axis, which is suitable for the treatment of hard surfaces and carpeted surfaces. The surface treatment activities, as well as the travel of the surface treatment unit 1, are controlled by a control and evaluation device 13 of the surface treatment unit 1. Furthermore, the surface treatment unit 1 has a surface type sensor 16, which is designed to detect and recognise surface types that are present in the environmental zones 7, 8, 9, 10. Here the surface type sensor 16 takes the form, for example, of an optical sensor, which is equipped to emit light signals, and to detect which surface type is present in the respective zone 7, 8, 9, 10 on the basis of the light components reflected from the surfaces to be treated. As an alternative to a recognition of the surface type by means of an evaluation of the degree of reflection, an alternative surface type sensor 16 can function on the basis of digital image processing, wherein images of the floor surface taken by the surface type sensor 16 are compared with reference images of known surface types, wherein a surface type is identified, as soon as an image that has been taken is matched with a reference image, or resembles it to a specific degree.

FIG. 2 shows an environmental map 4, which was generated by means of the map generation device 15 of the surface treatment unit 1. Alternatively, however, it is also possible for an external map generation device 15, for example a computing device located on a server, to generate the environmental map 4, and make it available to the surface treatment unit 1, that is to say, to its control and evaluation device 13 and its navigation device 6, for purposes of planning a route of travel 19. In the environmental map 4, for example, a total of four environmental zones 7, 8, 9, 10 of the environment are here noted. In the environmental zone 8 are located the surface treatment unit 1, and a base station 17, which is equipped to perform servicing activities on the surface treatment unit 1, including the charging of the energy storage device 3 of the surface treatment unit 1. Furthermore, the environmental map 4 stores surface type data 12 on the surface types detected by the surface type sensor 16 of the surface treatment unit 1, wherein the environmental zone 7 has a long-pile carpeted surface, the environmental zone 8 has a hard surface, the environmental zone 9 has a hard surface, and the environmental zone 10 has a short-pile carpeted surface. Furthermore, in the environmental map 4, energy data 11 associated with each environmental zone 7, 8, 9, 10 is stored, which indicates the amount of energy the surface treatment unit 1 will require to treat the floor surface that is present. The energy data 11 refers, for example, to a standard surface treatment activity, defined in this manner for the surface type in question. With respect to hard surfaces, for example, a specific suction power level of a fan, and a rotational speed of the surface treatment element 18, are defined. Similarly, standard surface treatment activities are also defined for long-pile and short-pile carpeted surfaces or carpets, which the surface treatment unit 1 automatically adopts, that is to say, performs, unless otherwise specified by a user of the surface treatment unit 1. The energy data 11 defined for surface treatment activities are stored directly in the environmental map 4; here for example as x₁ kWh, x₂ kWh, y₁ kWh and y₂ kWh. The amounts of energy relate to the entire surface treatment activity in the respective environmental zones 7, 8, 9, 10. Alternatively, it would be possible to store a required amount of energy per unit surface area in addition to the size of the environmental zones 7, 8, 9, 10, so that the control and evaluation device 13 can calculate the amount of energy required for the respective environmental zones 7, 8, 9, 10 from this data. If necessary, an environmental zone 7, 8, 9, 10 can also be divided into sub-zones, advantageously in order to be able to determine a route of travel 19 for the surface treatment of the environmental zones 7, 8, 9, 10. The amount of energy required to treat the environmental zones 7, 8, 9, 10 can be determined empirically on the basis of a plurality of surface treatment activities performed in the past by the surface treatment unit 1. However, the amount of energy can also be calculated theoretically from the surface type present in the environmental zone 7, 8, 9, 10, a knowledge of the energy requirements of the electrical loads on the surface treatment unit 1, a period of time usually required for the surface treatment activity, and other factors.

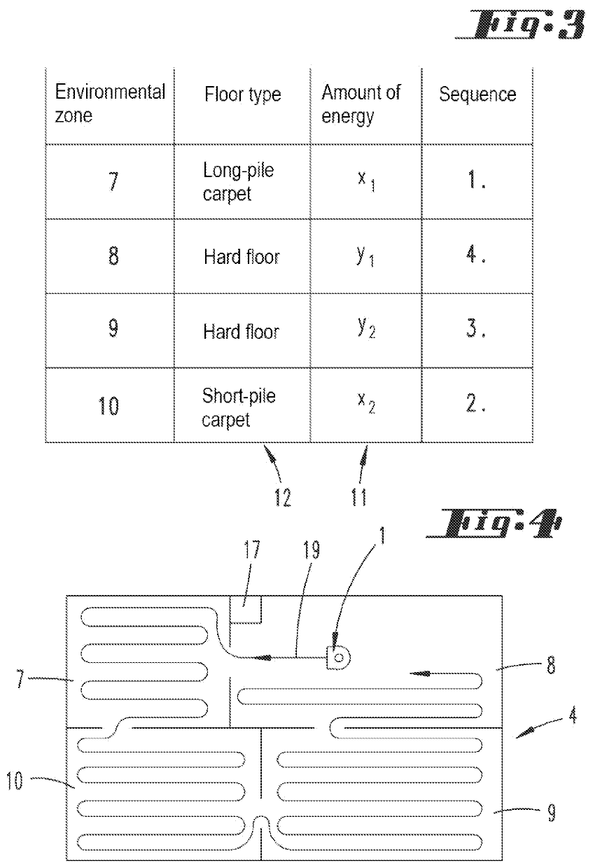

FIG. 3 shows a table, which contains the parameters of the environmental zones 7, 8, 9, 10. In the first column are the environmental zones 7, 8, 9, 10. The adjacent column to the right shows the surface type represented in the respective environmental zone 7, 8, 9, 10, differentiated into long-pile carpet, hard surface, short-pile carpet. In principle the surface type can be further sub-divided into various hard surfaces and similar. Furthermore, the next column to the right indicates the energy data 11, which includes an amount of energy required for the surface treatment of the respective environmental zones 7, 8, 9, 10, indicated here as x₁, x₂, y₁, y₂. On the basis of the data entered in the “amount of energy” column, the control and evaluation device 13 of the surface treatment unit 1 determines an environmental zone 7, 8, 9, 10 with the greatest energy requirement for the surface treatment of the respective environmental zone 7, 8, 9, 10. Here this is exemplified as the environmental zone 7 with the amount of energy “x₁” which is required for the surface treatment of the environmental zone 7 with a long-pile carpet. The control and evaluation device 13 of the surface treatment unit 1 then determines a sequence of the environmental zones 7, 8, 9, 10 for a route of travel 19 within which the surface treatment unit 1 moves through the environmental zones 7, 8, 9, 10 in order there to perform surface treatment activities in succession. Here the control and evaluation device 13 selects the sequence of the environmental zones 7, 8, 9, 10 such that particularly energy-intensive environmental zones 7, 8, 9, 10 are cleaned first, and, on the other hand, lower-energy environmental zones 7, 8, 9, 10 are only cleaned subsequently. Here, in accordance with the table column shown on the far right, a sequence is determined, which first provides for a surface treatment of the environmental zone 7, then a surface treatment of the environmental zone 10, then a surface treatment activity in the environmental zone 9, and finally a surface treatment of the environmental zone 8. In this case, the environmental zone 8, which has a hard surface, requires the smallest amount of energy “y₁”, which is less than the amounts of energy “x₁”, “y₂” and x₂” required for the treatment of the other environmental zones 7, 9, 10. Prioritisation of the treatment of an energy-intensive environmental zone 7, 8, 9, 10 ensures that the energy storage device 3 of the surface treatment unit 1 is quickly heated up to its operating temperature at the start of the route of travel 19, and the internal resistance of the energy storage device is reduced; this contributes to optimum operation and a prolongation of the service life of the energy storage device 3. Since, for example, the environmental zone 8, which requires the least amount of energy for surface treatment, is cleaned last, the energy storage device 3 can also cool down slowly again at the end of the route of travel 19, before the energy storage device 3 is recharged at the base station 17. This saves time for the entire surface treatment and recharging process, since the energy storage device 3 does not have to be cooled down separately before the actual charging activity can take place.

Finally, FIG. 4 shows the route of travel 19 that the control and evaluation device 13 of the surface treatment unit 1 has defined for the treatment of the environmental zones 7, 8, 9, 10. It can be seen that, starting from the current location of the surface treatment unit 1, the environmental zone 7 is the first to be cleaned, which does not correspond to the environmental zone 8 in which the surface treatment unit 1 is located at the start of the route of travel 19. Instead, the surface treatment unit 1 first travels to the neighbouring environmental zone 7, from there to the environmental zone 10, which also has a carpeted surface, and only then to the environmental zones 9 and 8, which have hard surfaces to be treated.

Although only a few embodiments of the present invention have been shown and described, it is to be understood that many changes and modifications may be made thereunto without departing from the spirit and scope of the invention.

### LIST OF REFERENCE SYMBOLS

1 Surface treatment unit
2 Drive device
3 Energy storage device
4 Environmental map
5 Data storage device
6 Navigation device
7 Environmental zone
8 Environmental zone
9 Environmental zone
10 Environmental zone
11 Energy data
12 Surface type data
13 Control and evaluation device
14 Obstacle sensor
15 Map generation device
16 Surface type sensor
17 Base station
18 Surface treatment element
19 Route of travel

What is claimed is:

1. A self-propelled surface treatment unit comprising:
a drive device configured for autonomous travel of the surface treatment unit within an environment,
an energy storage device,
a data storage device having an environmental map of the environment, and
a navigation device configured for navigation and self-location of the surface treatment unit within the environment, on the basis of the environmental map,
wherein the environmental map contains environmental zones, and
wherein the environmental map contains energy data for at least two of the environmental zones, the energy data for each one of the at least two environmental zones indicating an amount of energy that the surface treatment unit will require for the surface treatment of the respective environmental zone.

2. The surface treatment unit according to claim 1, wherein the amount of energy required for surface treatment of each one of the respective environmental zone is determined as a function of a surface type present in the respective environmental zone, and/or wherein the amount of energy is determined as a function of an empirically determined amount of energy for the treatment of the respective environmental zone.

3. The surface treatment unit according to claim 1, wherein the environmental map contains surface type data for a surface type represented in each one of the at least two environmental zones, wherein the surface type is selected from the group consisting of a hard surface, a short-pile carpeted surface, and a long-pile carpeted surface.

4. The surface treatment unit according to claim 1, wherein the environmental map indicates a characteristic amount of energy per unit surface area required for the surface treatment of each one of the at least two environmental zones.

5. The surface treatment unit according to claim 4, further comprising a control and evaluation device that is equipped to access the environmental map, to compare the characteristic amounts of energy for each one of the at least two environmental zones with one another, and, as a function of the characteristic amounts of energy, to determine a sequence in which the at least two environmental zones are treated in succession.

6. The surface treatment unit according to claim 5, wherein the control and evaluation device is equipped to determine the sequence, such that a first one of the at least two environmental zones, which requires a larger first amount of energy for surface treatment, is treated before a second one of the environmental zones, which requires a smaller second amount of energy for surface treatment, compared to the first amount of energy.

7. The surface treatment unit according to claim 5, wherein the control and evaluation device is equipped to apportion a total amount of energy stored in the energy storage device amongst a plurality of the environmental zones, so that energy-intensive environmental zones are treated first and, in contrast, less energy-intensive environmental zones are subsequently treated with respect to the required amount of energy in descending order, until the total amount of energy stored is fully apportioned.

8. The surface treatment unit according to claim 1, further comprising an obstacle sensor for detection of environmental features, and/or a map generation device for creation of the environmental map on the basis of environmental features, and/or a surface type sensor, which is equipped to determine a surface type that is present in one of the environmental zones.

9. A method for operation of the surface treatment unit according to claim 1, comprising storing data for the at least two environmental zones of the environmental map, which data indicates the amount of energy that the surface treatment unit will require for the surface treatment of the respective environmental zone.

10. The method according to claim 9, further comprising the steps of:
accessing the environmental map with a control and evaluation device of the surface treatment unit,
comparing the data regarding the required amounts of energy with one another, and,
as a function of the required amounts of energy, determining a sequence with which the environmental zones are treated in succession,
wherein the sequence is determined such that a first one of the environmental zones, which requires a greater first amount of energy for surface treatment, is treated before a second one of the environmental zones, which requires a smaller second amount of energy for surface treatment, compared to the first amount of energy.
